(19) United States
(12) Patent Application Publication
(10) Pub. No.: US 2011/0317000 A1
(43) Pub. Date: Dec. 29, 2011

(54) METHOD AND SYSTEM FOR ENHANCING MICROSCOPY IMAGE

(76) Inventors: Hwee Guan Lee, Singapore (SG); Mohammad Shorif Uddin, Singapore (SG)

(21) Appl. No.: 13/254,830

(22) PCT Filed: Feb. 11, 2010
(86) PCT No.: PCT/SG2010/000051

§ 371 Date: Sep. 2, 2011

(30) Foreign Application Priority Data
Mar. 5, 2009 (SG) 200901595-9

(51) Int. Cl. H04N 7/18

(52) U.S. Cl. 348/79; 348/E07.085

(57) ABSTRACT

A microscopy image, formed by illuminating a sample by shining light onto it in an illumination direction and capturing scattered light, is used to produce an enhanced image. This is done using an expression which links the intensity of the portions of the image to respective values of a scattering parameter at multiple respective elements of the sample. The scattering parameter may be an emission coefficient ρₑₘ or else equal to an absorption coefficient ρ_{αb}. This expression is solved to find the values of the scattering parameter. The scattering parameter is used to construct an enhanced image, for example an image which maps the variation of the scattering parameter itself. Provided the scattering parameter is found accurately, the enhanced image should be less subject than the original image to degradation due to non-uniform light attenuation and scattering.

### FIELD OF THE INVENTION

The present invention relates to a method and system for enhancing a microscopy image, that is an image acquired using a microscope. In particular, the enhanced image is one which suffers less from degradation due to non-uniform light attenuation and scattering.

### BACKGROUND OF THE INVENTION

Microscopy [1] is an important optical imaging technique for biology. While there are many microscopy techniques such as two-photon excitation microscopy and single plane illumination microscopy, confocal microscopy [1] has become one of the most important tools for bioimaging. In confocal microscopy, out-of-focus light is eliminated through the use of a pin-hole. Incident illuminating light passes through the pin-hole and gets focused onto a small region in the sample, where it is scattered by the sample. Only scattered light travelling along the same path as the incident illuminating light passes back through the pin-hole, and such light gets focused again at a light detector such as a photomultiplier tube, which generates an image. The images acquired through a confocal microscope are sharper than those produced by conventional wide-field microscopes. However, degradation by light attenuation effects is acute in confocal microscopy. The fundamental problem in confocal microscopy is the light penetration problem. Incident light is attenuated as it is scattered, and hence cannot penetrate through thick samples. As a result, images acquired from regions deep into the sample appear exponentially darker than images acquired from regions near the surface of the sample. Difficulties in light penetration are not restricted to confocal microscopy. Other light microscopy techniques, such as the single plane illumination microscopy and wide-field microscopy suffer the same problem. The classical space invariant deconvolution approaches [2], [3], [4] cannot cope with this problem of microscopy imaging.

Attempts to solve the above-mentioned problem have been made by either increasing the laser power or increasing the sensitivity of the photomultiplier tube [20]. Both techniques are inadequate and have drawbacks: increasing laser power accelerates photo-bleaching effects whereas increasing the sensitivity of the photo-multiplier tube adds noise. Umesh Adiga and B. B. Chaudhury [21] discussed the use of a simple thresholding method to separate the background from the foreground for restoring images taking into consideration light attenuation along the depth of the image stack. This technique makes an assumption that image voxels are isotropic (which is not true for confocal microscopy) based on XOR contouring and morphing to virtually insert the image slices in the image stack for improving axial resolution.

A seemingly unrelated technical field is the field of outdoor imaging. Within that field the issue of the restoration of degraded images due to atmospheric aerosols has been extensively studied [5], [6], [7], [8], [9], [10], [11], [12], [13] due to its important applications such as surveillance, navigation, tracking and remote sensing [5], [10]. Similar restoration techniques as those used in the restoration of these degraded images also found new applications in underwater vision [8], [9], specifically for surveillance of underwater cables and pipeline, etc. Various restoration algorithms are proposed based on physical models of light attenuation and light scattering (airlight) through a uniform media. One of the earlier works [5] on such image restoration algorithms requires accurate information of scene depths. Subsequent works circumvented the need for scene depths, but require multiple images to recover the information needed [8], [9], [10], [14]. Narasimhan and Nayar [10], [11], [12], [13] developed an interactive algorithm that extracts all the required information from only one degraded image. This method needs manual selection of airlight color and a “good color region”. A fundamental issue with these restoration techniques is the amplification of noise. An attempt to handle this fundamental issue is done through the use of a regularization term in a variational approach proposed by Kaftory et. al. [14].

### SUMMARY OF THE INVENTION

The present invention aims to provide a method for restoring images which can overcome the above problems.

In general terms the invention proposes that a microscopy image, formed by illuminating a sample by shining light onto it in an illumination direction and capturing scattered light, is used to produce an enhanced image. This is done using an expression which links the intensity of the portions of the microscopy image to respective values of a scattering parameter at multiple respective elements of the sample. The scattering parameter may be an emission coefficient ρₑₘ or else equal to an absorption coefficient ρ_{αb}. This expression is solved to find the values of the scattering parameters. The values of the scattering parameter are used to construct the enhanced image, for example an image which maps the variation of the scattering parameter itself.

Provided the values of the scattering parameter are found accurately, the enhanced image should be less subject than the original image to degradation due to non-uniform light attenuation and scattering.

The expression may give the value of the scattering parameter for each element as a function of the values of the scattering parameter of elements which are along the direction of the incident light. In this case, the values of the scattering parameter may be found successively for locations successively further in the illumination direction.

The expression may employ an average value of the scattering parameter, defined over a region which encircles a set of elements parallel to the illumination direction.

The invention may alternatively be expressed as a computer system for performing such a method. This computer system may be integrated with a device, for example a microscope, for acquiring images. The invention may also be expressed as a computer program product, such as one recorded on a tangible computer medium, containing program instructions operable by a computer system to perform the steps of the method.

### BRIEF DESCRIPTION OF THE FIGURES

An embodiment of the invention will now be illustrated for the sake of example only with reference to the following drawings, in which:

FIG. 1 illustrates a flow diagram of a method for enhancing a microscopy image according to an embodiment of the present invention;

FIG. 2 illustrates the attenuation of light incident on an element of a sample;

FIG. 3 illustrates the scattering of light emitted by an infinitesimal volume;

FIG. 4 illustrates the geometry for confocal microscopy;

FIG. 5 illustrates the process of generating a plurality of z-stacks between the focusing lens of the microscope and the sample;

FIG. 6 illustrates the side scattering geometry for single plane illuminating microscopy;

FIGS. 7(a)-(d) illustrate a set of enhancement results obtained using the method of FIG. 1 wherein the input images are images of samples prepared using fluorescein and liquid gel and are acquired using confocal microscopy;

FIGS. 8(a)-(c) illustrate a first set of enhancement results obtained using the method of FIG. 1 wherein the input images are images of neuro-stem cells and are acquired using confocal microscopy;

FIGS. 9(a)-(c) illustrate a second set of enhancement results obtained using the method of FIG. 1 wherein the input images are images of neuro-stem cells and are acquired using confocal microscopy;

FIG. 10 illustrates a set of enhancement results obtained using the method of FIG. 1 wherein the input images are synthetically degraded images and are acquired using single plane illuminating microscopy; and

FIGS. 11(a)-(b) illustrate the effects of varying the value of 1/α′n₀ on the enhancement results obtained using the method of FIG. 1 wherein the input images are synthetically degraded images and are acquired using single plane illuminating microscopy.

### DETAILED DESCRIPTION OF THE EMBODIMENTS

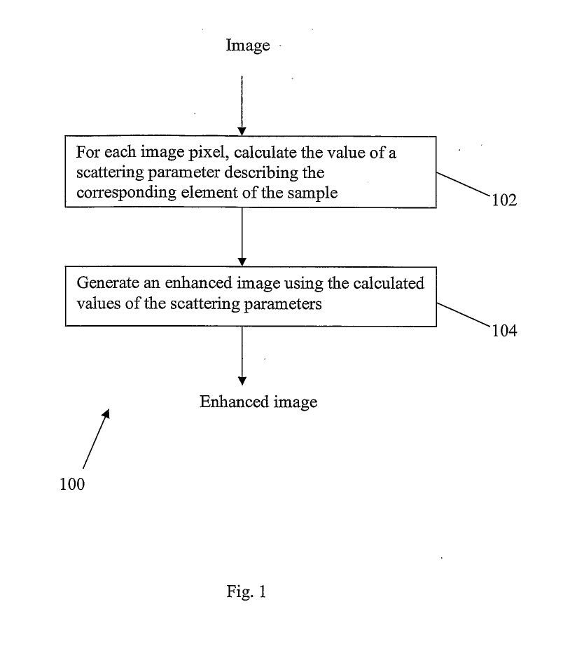

Referring to FIG. 1, the steps are illustrated of a method 100 which is an embodiment of the present invention, and which is a method for enhancing a microscopy image.

The input to method 100 is an image of a sample acquired using a microscope which illuminates the sample and collects light absorbed and then scattered by the elements of the sample. Pixels of the image correspond to elements of the sample. The intensity at each point in the sample is the sum of a component of incident light (gradually attenuated as it passes through the sample) and a scattering component due to the scattering. The scattering of incident light by a given element of the sample is described by the value of a scattering parameter, which is typically an emission coefficient ρₑₘ or else equal to an absorption coefficient ρ_{αb}. In step 102, for each image pixel, the value of the scattering parameter of the corresponding element is calculated using a mathematical expression linking the values of the scattering parameters and the intensities of the image. In step 104, an enhanced image is formed using the calculated values of the scattering parameters. The input image may be linearly normalized prior to step 102. Furthermore, method 100 may further comprise a step of linearly scaling intensities of pixels in the enhanced image to the range of 0-(2ⁿ−1) where n is the number of bits used to represent the pixels.

The derivation of the mathematical expression is discussed below. The discussion as follows further includes a discussion on how to solve the expression in the cases of confocal microscopy and of a side scattering geometry.

1. Field Theoretical Formulation

Assume a region of interest Ω∈ [symbol] ³ that contains the whole imaging system, including the sample, possibly an attenuation medium, light sources and detectors (e.g. camera). Although in reality, the light sources can originate from infinity, in one example, the light sources are considered to originate from the boundary of the region of interest ∂Ω. Note however that this is not a requirement in the embodiments of the present invention. rₛ ∈Ωₛ is a set of points in the light sources and rₚ are the locations of the voxels in the detector.

1.1 Photon Density and Light Intensity

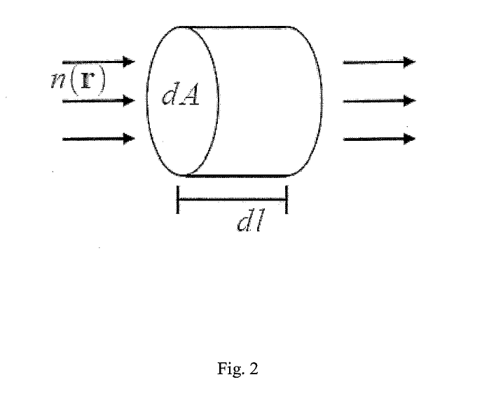

The mathematical model of photon (light) density and light intensity field is described as follows. FIG. 2 illustrates the attenuation of light incident on an element of the sample. In FIG. 2, dl and dA indicate an infinitesimal length and an infinitesimal area of the element, respectively. In Equation (1), c is the speed of light in the medium, and f(r)dldA is the total number of photons in an infinitesimal volume dV=dldA (See FIG. 2). Equation (1) gives the relationship between the number of photons per unit volume f(r) and the light intensity n(r), n(r) being the number of photons passing through a unit area per unit time.

$$n ( r ) dA = f ( r ) \frac{d l}{d t} dA = f ( r ) cdA ⇒ n ( r ) = f ( r ) c \qquad ( 1 )$$

1.2 Attenuation and Absorption Coefficient

The degree of attenuation of light through a medium depends on the opacity of the medium as well as the distance traveled through the medium. Referring to FIG. 2, suppose light is incident on the element along the x-axis at a point r (as shown by the arrows labeled as n(r) in FIG. 2), the differential change of intensity through the medium with an infinitesimal thickness dl is given by Equation (2). In Equation (2), ρ_{αb}(r) is the absorption coefficient of light at a point r. In several papers ρ_{αb}(r) is also known as the extinction coefficient [5], [8], [14]. Note that ρ_{αb}(r)is in general a function of the wavelength of light i.e. ρ_{αb}=ρ_{αb}_{_{λ}}, but for simplicity the subscript is omitted in the following discussion. Generalization of these equations may be performed straightforwardly to handle multiple wavelengths.

$$\frac{d n ( r )}{d l} = - n ( r ) {ρ}_{ab} ( r ) \qquad ( 2 )$$

To calculate the total attenuation effects from a light source at rₛ to a point r, Equation (2) is integrated from rₛ to r as shown in Equation (3) where γ(rₛ:r) denotes a light ray joining rₛ and r.

n(r)=n(rₛ)exp(−∫_{γ(r}_{ₛ}_{:r)}ρ_{αb}(r′)dl) (3)

Equation (4), which describes the total attenuation effects from rₛ to r, is then derived by summing n(r) in Equation (3) over rays from all the light sources to point r. In Equation (4), n_{A}(r) with the subscript A denotes the light intensity due to the attenuation component and is the total light intensity arising from all the light sources and attenuated along light rays between the light sources and the point r(rₛ ∈Ωₛ). Equation (4) states that light intensity decays exponentially in general, with the rate of exponential decay varying at different points.

$${n}_{A} ( r ) = {\sum }_{{r}_{s} ∈ {Ω}_{s} , γ ( {r}_{s} : r )} n ( {r}_{s} ) exp ( - {\int }_{γ ( {r}_{s} : r )} {ρ}_{ab} ( {r}^{′} ) d l ) \qquad ( 4 )$$

1.3 Photon Absorption and Emission Rates

The rates of photon absorption and emission are related using the continuity equation [18] as shown in Equation (5) in which \hat{v} is the direction of incident light.

$$\frac{\partial f ( r )}{\partial t} + ∇ \cdot f ( r ) \hat{v} c = 0 \qquad ( 5 )$$

Combining Equations (1) and (5), the number of absorbed photons per unit volume per unit time is given in Equation (6).

$$\frac{\partial f ( r )}{\partial t} = - \frac{d n ( r )}{d l} \qquad ( 6 )$$

Relating the continuity equation (i.e. Equation (5)) to Equation (2), Equation (7), which describes the number of photons per unit volume per unit time, is derived.

$$\frac{\partial f ( r )}{\partial t} = n ( r ) {ρ}_{ab} ( r ) \qquad ( 7 )$$

1.4 Scattering and Emission Coefficient

Since the medium scatters light in all directions, the scattered light can be absorbed and scattered again by particles in other parts of the medium. If the number of absorbed photons is equal to the number of emitted photons, then the number of photons emitted per unit volume per unit time is dn(r)/dl and by Equation (7), the rate of light emitted by an infinitesimal volume dr′ at r′ is given by n(r′)ρ_{αb}(r′)dr′. However, some light energy may be dissipated through heat or by some other means. For a dissipative medium, some light energy is dissipated. In this specification, ρₑₘ is used to represent the emission coefficient, with the rate of emission given by n(r′)ρₑₘ(r′)dr′ wherein n(r′)ρₑₘ(r′)dr′≦n(r′)ρ_{αb}(r′)dr′.

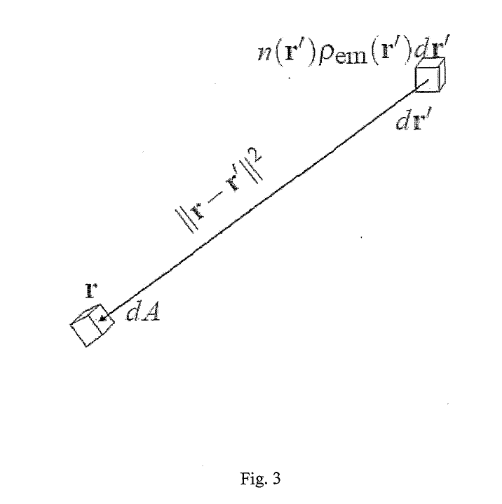

FIG. 3 illustrates the scattering of light emitted by an infinitesimal volume. As shown in FIG. 3, the total number of photons emitted by an infinitesimal volume dr′ is given by n(r′)ρₑₘ(r′). Referring to FIG. 3, a fraction of these photons reaches point r and the infinitesimal incident light intensity received at point r due to scattering of the light from the infinitesimal volume dr′ is given in Equation (8).

$$d {n}_{s} ( r ) = ( \frac{n ( {r}^{′} ) {ρ}_{em} ( {r}^{′} ) d {r}^{′}}{4 π {‖ r - {r}^{′} ‖}^{2}} ) ( {e}^{- {\int }_{γ ( {r}^{′} : r )} {ρ}_{ab} ( {r}^{″} ) d l} ) \qquad ( 8 )$$

In Equation (8), the subscript S stands for scattering component, and γ(r′:r) is a light ray from r′ to r. The denominator in the first term is a geometric factor that reflects the geometry of 3D space. The numerator is the number of photons emitted per unit time by the volume element dr′. The second term represents the attenuation of light from r′ to r. Integrating over all r′∈Ω,r′≠r, the total scattered light received at point r is given in Equation (9)

$${n}_{s} ( r ) = {\int }_{Ω , r \neq {r}^{′}} \frac{n ( {r}^{′} ) {ρ}_{em} ( {r}^{′} ) {e}^{- {\int }_{γ ( {r}^{′} : r )} {ρ}_{ab} ( {r}^{″} ) d l}}{4 π {‖ r - {r}^{′} ‖}^{2}} d {r}^{′} \qquad ( 9 )$$

1.5 Image Formation

The total light intensity at a point r ∈Ω can be written as a sum of the attenuation and scattering components as shown in Equation (10).

$$\begin{matrix}n ( r ) = {n}_{A} ( r ) + {n}_{s} ( r ) \\ = {\sum }_{{r}_{s} ∈ {Ω}_{s} , γ ( {r}_{s} : r )} n ( {r}_{s} ) {e}^{- {\int }_{γ ( {r}_{s} : r )} {ρ}_{ab} ( {r}^{′} ) d l} + \\ {\int }_{Ω , r \neq {r}^{′}} \frac{n ( {r}^{′} ) {ρ}_{em} ( {r}^{′} ) {e}^{- {\int }_{γ ( {r}^{′} : r )} {ρ}_{ab} ( {r}^{″} ) d l}}{4 π {‖ r - {r}^{′} ‖}^{2}} d {r}^{′}\end{matrix} \qquad ( 10 )$$

The physical model as described in Equation (10) can be related to the observed image. The total amount of light emitted per unit time by an infinitesimal volume dr is ρₑₘ(r)n(r)dr. Suppose the detector detects a part of this light to form pixel rₚ in the 3-dimensional observed image u₀ (for example, in confocal microscopy), the pixel intensity at rₚ is given by Equation (11) as u₀(rₚ).

u₀(rₚ)=∫_{r∈Ω,γ(r:r}_{ₚ}₎αᵣρₑₘ(r)n(r)e^{-∫}^{_{γ}}^{ρ}^{_{αb}}^{(r′)dl}dr (11)

The integral in Equation (11) is performed over all light rays from all points r ∈Ω to the point rₚ. The attenuation term appears again in this equation as light is attenuated when traveling from the medium location r to the pixel location rₚ. α_{γ}=α_{γ}(r,rₚ) is a function that depends on the lensing system of the detector. The subscript γ is used to indicate that α_{γ}, depends on the path of the light.

The objective of imaging is to find out what objects are present in the region of interest Ω. In other words, it is necessary to find out the optical properties of the materials in Ω. These properties are given by ρ_{αb}(r) and ρₑₘ(r). Given the observed image u₀(rₚ), ρ_{αb}(r) and ρₑₘ(r) are estimated by solving Equation (11) for these parameters.

The following observations are made of the above equations:

1. Geometry: All geometrical information is embedded in the paths γ(r,r′), which represents light rays from point r to r′.

2. Light Source: Light source information is given by the summation over Ωₛ and γ(rₛ:r) in Equation (4).

3. Airlight: An airlight effect [10] is known in the field of outdoor imaging, in which water particles in the atmosphere reflect sunlight towards the observer, and thus act as a source of light. An analogous effect arises in the present microscopy field, and is included in the scattering component (See Equation (10)).

4. Non-unique solution: The solution of Equation (11) is non-unique in general. Consider, for example, a case when Ω contains an opaque box and an image is taken of this box. Since the box is opaque, the values of ρ_{αb} and ρₑₘ within the box are undefined.

1.6 Discretization

A matrix equation is derived by first discretizing the total light intensity (Equation (10)) at each point r to form N finite elements. The N finite elements are denoted rᵢ where i=1, . . . N is an integer index labeling the finite-elements. The finite elements are referred to below as “voxels”, and the discretization is performed such that each respective voxel rₚ in the image data corresponds to one of the voxels rᵢ. In Equation (12), the summation over rₖ ∈γ(rⱼ:rᵢ) is the sum over all finite elements that the ray γ(rⱼ:rᵢ) passes through. ρ_{αb}(rₖ) is the absorption coefficient at voxel k and Δrₖ is the length of the segment of γ(rⱼ:rᵢ) that lies within voxel k. ΔV is the voxel volume. Equation (10) can then be re-written as:

$$\begin{matrix}n ( {r}_{i} ) = {n}_{A} ( {r}_{i} ) + {n}_{s} ( {r}_{i} ) \\ = {\sum }_{{r}_{s} ∈ {Ω}_{s} , γ ( {r}_{s} : {r}_{i} )} n ( {r}_{s} ) {e}^{- {\sum }_{{r}_{k} ∈ γ ( {r}_{s} : {r}_{i} )} {ρ}_{ab} ( {r}_{k} ) Δ {r}_{k}} + \\ {\sum }_{i \neq j} \frac{n ( {r}_{j} ) {ρ}_{em} ( {r}_{j} ) {e}^{- {\sum }_{{r}_{k} ∈ γ ( {r}_{j} : {r}_{i} )} {ρ}_{ab} ( {r}_{k} ) Δ {r}_{k}}}{4 π {‖ {r}_{i} - {r}_{j} ‖}^{2}} Δ V\end{matrix} \qquad ( 12 )$$

For each i=1, . . . ,N, we define bᵢ(rᵢ)bybᵢ(rᵢ)=n_{A}(rᵢ) and uᵢ(rᵢ) (or in short, uᵢ) by u_{i/}ρₑₘ(rᵢ)=n(rᵢ). It follows that Equation (12) can be rewritten as:

$$\frac{{u}_{i}}{{ρ}_{em} ( {r}_{i} )} = {b}_{i} + {\sum }_{j \neq i} ( \frac{exp ( - {\sum }_{{r}_{k} ∈ γ ( {r}_{j} : {r}_{i} )} {ρ}_{ab} ( {r}_{k} ) Δ {r}_{k} )}{4 π {‖ {r}_{i} - {r}_{j} ‖}^{2}} Δ V ) {u}_{j} \qquad ( 13 )$$

We define G(rᵢ,rⱼ) by Equation (14):

$$G ( {r}_{i} , {r}_{j} ) = \{ \begin{matrix}- \frac{exp ( - {\sum }_{{r}_{k} ∈ γ ( {r}_{j} : {r}_{i} )} {ρ}_{ab} ( {r}_{k} ) Δ {r}_{k} )}{4 π {‖ {r}_{i} - {r}_{j} ‖}^{2}} Δ V & i \neq j \\ \frac{1}{{ρ}_{em} ( {r}_{i} )} & i = j\end{matrix} \qquad ( 14 )$$

Equation (13) can be rewritten as:

$$b ( {r}_{i} ) = {\sum }_{j} G ( {r}_{i} , {r}_{j} ) n ( {r}_{j} ) {ρ}_{em} ( {r}_{j} ) \qquad ( 15 )$$

Defining Gᵢⱼ=G(rᵢ,rⱼ) and u=(u₁, . . . , u_{N}) and b=(b₁, . . . , b_{N}) , Equation (15) can be re-written in matrix form as shown in Equation (16):

b=G·u (16)

Equation (16) may be solved numerically using Equation (16a) as shown below whereby ρ=ρ_{αb}(r) which may in turn be equal to q⁻¹ρₑₘ(r) or ρₑₘ(r). Since ρ>0, the absolute sign is required in Equation (16a) to avoid the Karush-Kuhn-Tucker condition.

$$J ( ρ ) = ‖ b - G \cdot u ‖ \\ {ρ}^{*} = \vert arg {min}_{ρ} J ( \vert ρ \vert ) \vert \qquad ( 16 a )$$

2. Confocal Microscopy

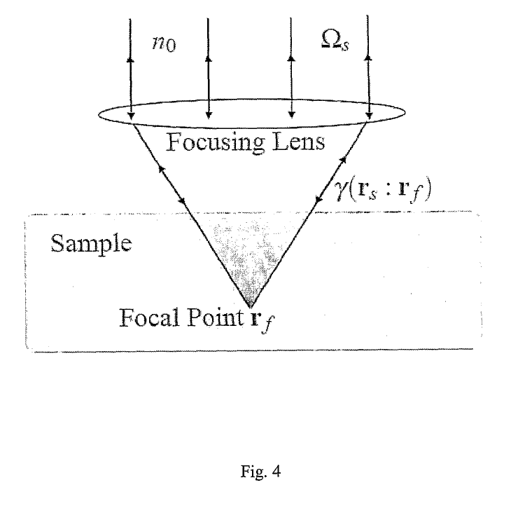

FIG. 4 shows the geometry for a confocal microscopy setup. Incident light passes through the focusing lens and is focused at the point r_{f}. The summation over all light rays in Equation (4) sums over all rays from the focusing lens γ(rₛ:r_{f}). The area of the lens can be taken to be a set of points the incident light originates from, in other words, the set of points in the incident light sources Ωₛ. Detected light travels via the same paths through the focusing lens. Hence the summation over all light rays in Equation (11) is performed over the same paths γ(rₛ:r_{f}) but in the opposite direction. In one example, the emission coefficient ρₑₘ, is related to the absorption coefficient ρ_{αb} by the quantum yield of fluorophores [19] i.e. related to the absorption coefficient ρ_{αb} by the quantum yield q. Writing ρ_{αb}(r) more simply as ρ(r), we obtain ρ(r)=q⁻¹ρₑₘ(r). For example, when fluorescein is used as the fluorophore, q takes the value of 0.92 and when Hoescht 33342 is used as the flurophore, q takes the value of 0.83. Alternatively, it may be possible that in fluorescence microscopy, the fluorophore absorbs the photon and almost immediately re-emits them. Hence, in another example, the total number of photons absorbed is assumed to be equal to the total number of photons emitted (i.e. q=1) and ρ(r) is set as ρ(r)=ρₑₘ(r)=ρ_{αb}(r).

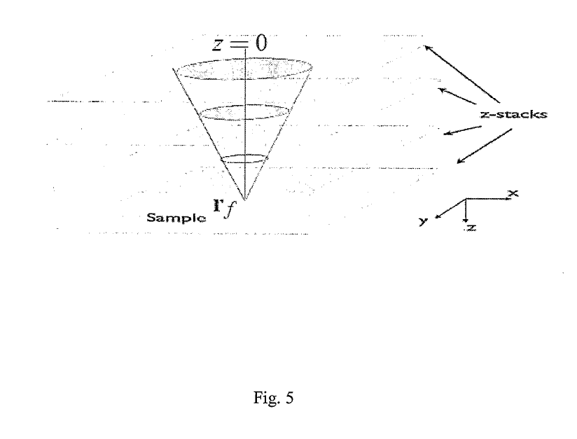

FIG. 5 illustrates how the sample is scanned in discrete locations to generate z-stacks (shaded in gray) in the image acquisition process. In one example, the focusing lens is first placed at a specific focal length away from the first slice z=0. After capturing an image of this first slice z=0, the focusing lens is shifted to a second position at the same focal length away from the second slice z=1 and an image of the second slice z=1 is captured. This process is repeated until the images of all the slices have been captured.

An approximation is used to simplify Equation (4) and Equation (11) by calculating the mean ρ(r) (i.e. [symbol] ρ [symbol] (z)) over the disk area of the light cone for each z-stack as shown in Equation (17).

$$〈 ρ 〉 ( z ) = \frac{{\int }_{disk} d x d y ρ ( x , y , z )}{{\int }_{disk} d x d y} \qquad ( 17 )$$

Using Equation (17), and making the assumption that there is a constant incident light intensity n₀ at the focusing lens, Equation (4) can be written as Equation (18):

$$\begin{matrix}{n}_{A} ( r ) = {n}_{0} {\sum }_{{r}_{s} ∈ {Ω}_{s} ; γ ( {r}_{s} : r )} exp ( - {\int }_{γ ( {r}_{s} : r )} ρ ( {r}^{′} ) d l ) \\ \approx {n}_{0} exp ( - {\int }_{z = 0}^{{r}_{f}} 〈 ρ 〉 ( z ) d z ) {\sum }_{{r}_{s} ∈ {Ω}_{s} ; γ ( {r}_{s} : r )} \\ \approx β {n}_{0} exp ( - {\int }_{z = 0}^{{r}_{f}} 〈 ρ 〉 ( z ) d z )\end{matrix} \qquad ( 18 )$$

where β=Σᵣ_{ₛ}_{∈Ω}_{ₛ}_{,γ(r}_{ₛ}_{:r)}·β is a complicated function of the light paths but is a constant number as long as the focal length of the focusing lens does not change.

For confocal microscopy, only light emitted at r_{f} is collected by the photomultiplier as shown in FIG. 4. Hence, ρₑₘ and ρ_{αb} in Equation (11) can be replaced using [symbol] ρ [symbol] defined in Equation (17) to obtain Equation (19). In Equation (19), ΔV_{f} is the confocal volume, α′=Σ_{γ(r}_{_{f}}_{,r}_{ₚ}₎q⁻¹α_{γ}ΔV_{f} is a constant number and u(r)=ρ(r)n(r). Equation (19) as shown below is derived by setting ρ(r) as ρ(r)=ρ_{αb}(r)=q⁻¹ρₑₘ(r). If it is assumed that ρ_{αb} (r)=ρₑₘ(r), the term q is omitted from Equation (19).

$$\begin{matrix}{u}_{0} ( {r}_{p} ) = {\int }_{r ∈ Ω , γ ( r : {r}_{p} )} {α}_{γ} q ρ ( r ) n ( r ) {e}^{- {\int }_{γ} ρ ( {r}^{′} ) d l} d r \\ \approx n ( {r}_{f} ) ρ ( {r}_{f} ) {e}^{- {\int }_{z = 0}^{{r}_{f}} 〈 ρ 〉 ( z ) d z} {\sum }_{γ ( {r}_{f} , {r}_{p} )} q {α}_{γ} Δ {V}_{f} \\ = {α}^{′} u ( {r}_{f} ) {e}^{- {\int }_{z = 0}^{{r}_{f}} 〈 ρ 〉 ( z ) d z}\end{matrix} \qquad ( 19 )$$

In one example, an analytic solution for Equation (16) is obtained by assuming that the scattering terms are negligible (i.e. nₛ<<n_{A}, n(r)≅n_{A}(r), in other words, Gᵢⱼ=0 for i≠j and Gᵢⱼ=1/ρ(r_{f})). Putting this in another way, the assumption is that the light intensity at each element of the sample includes only a negligible component due to scattering from other elements. Substituting Equations (18) and (19) into Equation (16), Equation (20) is obtained

$${ρ}_{A} ( {r}_{i} ) = \frac{{u}_{0 i}}{{α}^{′} β {n}_{0}} exp ( 2 {\int }_{z = 0}^{{z}_{i}} 〈 ρ 〉 ( z ) d z ) \qquad ( 20 )$$

where u₀ᵢ=u₀(rᵢ) and ρ_{A} in Equation (20) is the true light emission coefficient if the scattering terms are neglected. The image is enhanced in method 100 using the emission coefficient ρ_{A}(rᵢ) calculated for each image pixel rᵢ.

In one example, ρ_{A} is calculated from the observed image slice-by-slice through the z-stack, starting from the first slice.

1. For the first slice, z=0, the integral in Equation (20) gives a value of zero i.e. ρ_{A}(rᵢz=0)=u_{0i/}α′βn₀. This implies that ρ_{A} is proportional to the intensity in the observed image. In one example, α′β is a tuning parameter which can be calibrated so as to make the illumination most uniform.

2. ρ_{A} for the second slice depends on ρ_{A} for the first slice according to

Equation (21) where Δz is the thickness of the discretized z-stack and [symbol] ρ_{A}(z=0) [symbol] is an average value calculated using values of ρ_{A} for the first slice.

$${ρ}_{A} ( {r}_{i} , z = 1 ) = \frac{{u}_{0 i}}{{α}^{′} β {n}_{0}} exp ( 2 〈 {ρ}_{A} 〉 ( z = 0 ) Δ z ) \qquad ( 21 )$$

3. ρ_{A} for the k-th slice is given by Equation (22). Since the values of ρ_{A} are calculated slice-by-slice starting from the first slice, at the point of calculating ρ_{A} for the k-th slice, the values of ρ_{A} are already obtained for all the slices from the first slice to the (k-1)-th slice. Hence, the value of the term,

$${\sum }_{z = 0}^{k - 1} 〈 {ρ}_{A} 〉 ( z ) Δ z$$

can be easily obtained. To obtain the whole enhanced image, ρ_{A} from the first to the last slice is calculated in sequence.

$${ρ}_{A} ( {r}_{i} , z = k ) = \frac{{u}_{0 i}}{{α}^{′} β {n}_{0}} exp ( 2 {\sum }_{z = 0}^{k - 1} 〈 {ρ}_{A} 〉 ( z ) Δ z ) \qquad ( 22 )$$

Alternatively, the scattering term may be included when solving Equation (16). Inclusion of the scattering term results in non-analytic solutions, which can be solved numerically by Equation (16a) as shown above. Equation (16a) may be used together with bᵢ=b(rᵢ)=n_{A}(rᵢ) according to Equation (18)) and uᵢ=u₀(rᵢ)exp(∫_{z=0}^{r}^{_{f}} [symbol] ρ [symbol] dz)/α′ according to Equation (19). Vectors b, u and matrix G are formed for each voxel in the image with the matrix G formed according to Equation (14). For i≠j, the calculation of Gᵢⱼ involves a summation of ρ_{αb} (rₖ)Δrₖ along the light rays (i.e. straight lines) between points, rᵢ and rⱼ. To reduce computation time, sampling may be performed when calculating the mean ρ(r) over the disk area of the light cone for each z-stack.

Alternatively, equation (16a) can be solved numerically using the gradient descent method because ∂J/∂ρₖ,∀k can be evaluated numerically. In one example, ρ_{A}(in Equation (20)) is used for the initial guess of ρ in the gradient descend method. Through the numerical simulations performed using the embodiments of the present invention, it is found that ρ_{A} (in Equation (20)) is a good approximation to ρ. Using ρ_{A} (in Equation (20)) as an initial guess for ρ reduces the local minimum problem in the gradient descend method.

3. Side Scattering Geometry

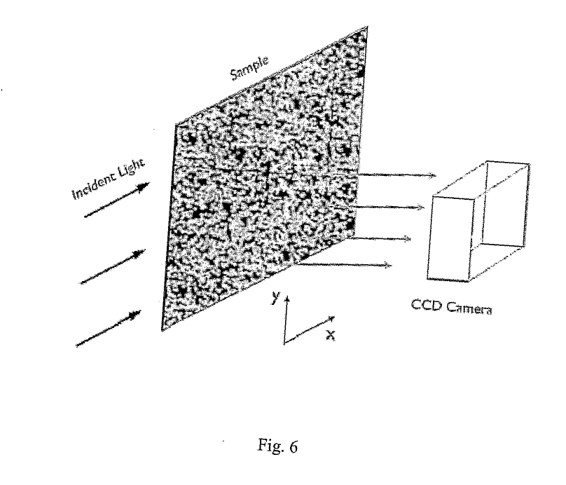

Side scattering geometry is in reality, the geometry for Single Plane Illumination Microscopy (SPIM) [22], [23], [24], [25], [26]. FIG. 6 shows the geometrical arrangement of side scattering wherein the light source originates from the side and illuminates one plane of the sample, i.e. “Sample” in FIG. 6. As shown in FIG. 6, scattered light is collected in an orthogonal direction by a CCD camera. In this geometrical arrangement, the incident light rays are constant and parallel. Equation (4) can be reduced to the following Equation (24) by denoting the constant incident intensity at a point r=(x, y) as n₀. In Equation (24), the integration is over the horizontal x-direction as shown in FIG. 6. As in the case of confocal microscopy, ρ can be set as ρ=q⁻¹ρₑₘ=ρ_{αb}.

n_{A}(r)=n₀exp(−∫_{γ(r}_{ₛ}_{:r)}ρ(r′)dl) (24)

It is assumed that the scattered light travels directly to the CCD camera without any attenuation. As in most camera set ups, there is a one-to-one correspondence between the pixel point rₚ (in the CCD camera) and the sample location r. Hence, Equation (11) may be written as Equation (25) as shown below where α′ represents the integrated effects of quantum yield and the detector (when ρ=q⁻¹ρₑₘ=ρ_{αb} is used), including summations over all rays etc.

u₀(r)=α′ρ(r)n(r)=α′u(r) (25)

Using Equation (25), the matrix equation in Equation (16) can be written as Equation (26).

b=G·u_{0/}α′ (26)

In one example, an analytic solution is obtained as shown in Equation (27) by assuming that the scattering term is negligible. In Equation (27), the subscript A is used to indicate that an approximated solution is obtained using the attenuation term alone. With this approximation, Equation (27) can be more easily solved numerically. The summation in Equation (27) is performed along light rays (i.e. straight lines) in the direction of the laser beam from the light sources rₛ to the respective points rᵢ.

$${ρ}_{A} ( {r}_{i} ) = \frac{1}{{α}^{′} {n}_{0}} {u}_{0} ( {r}_{i} ) exp ( {\sum }_{{r}_{k} ∈ γ ( {r}_{s} , {r}_{i} )} ρ ( {r}_{k} ) Δ {r}_{k} ) \qquad ( 27 )$$

The numerical experiments in the embodiments of the present invention showed that the enhanced image using Equation (26) and the enhanced image using Equation (16a) differ by about 1% only, indicating that the approximation of nₛ<<n_{A} is valid.

4. Results

Numerical calculations are performed and the results are compared to ground truths. Comparison with other physics-based restoration methods [5], [6], [7], [8], [9], [10], [11], [12], [13] is not possible because these methods cannot be applied to microscopy images. Firstly, other physics-based methods are not designed to enhance three-dimensional images. Secondly, these methods assume a constant attenuation media, an assumption that is strongly violated in microscopy images.

4.1 Validation and Calibration

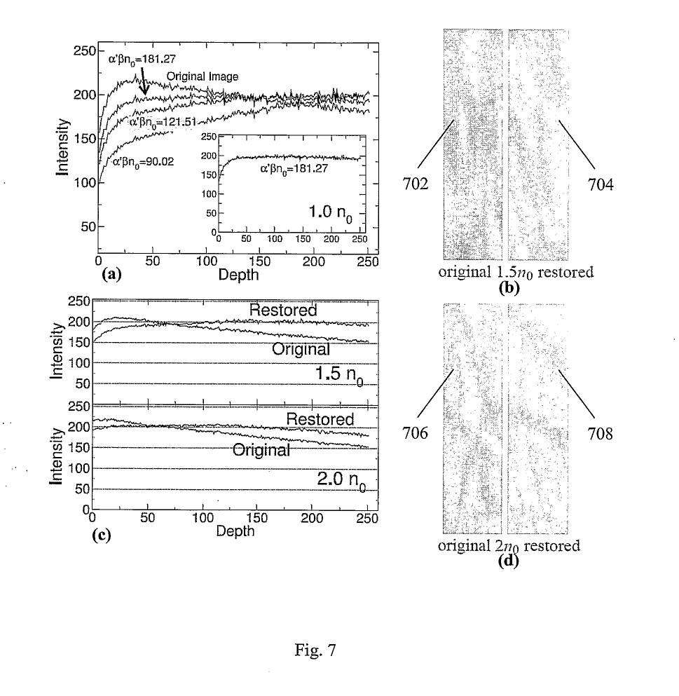

Method 100 is validated on specially prepared samples in which the ground truth is known by experimental design. Image enhancement is then performed using method 100 and the results obtained are compared to the ground truth. In the experiment, a sample is made by mixing fluorescein and liquid gel on an orbital shaker until the gel hardens. In this way, the sample is uniform throughout the 3D volume. However, the intensity profile of the acquired image will not be uniform due to attenuation. Instead, it decreases with depth. As shown in FIG. 7(a), each of the images enhanced using method 100 has a more uniform intensity profile (maximum intensity projection) than the original input image. The enhanced images are denoted as “restored” in FIG. 7. The parameter α′βn₀ is calibrated with respect to the microscope. As shown in FIG. 7(a), α′βn₀=181.27 gives the best result. On the other hand, lower values 121.51 and 90.02 result in over compensation. Denoting the value of the parameter α′βn as C, the relationship between two parameters (C₁, C₂) with different laser intensities (n₁, n₂) is simply C₁/ C₂=n₁/n₂. Hence, the calibrated parameter value for FIG. 7(a) can also be used for images taken with different laser intensities, for example 1.5n₀ and 2.0n₀ as shown in FIG. 7(c), where n₀ is the laser intensity used in FIG. 7(a). in FIG. 7(b), 2D projections of the original image 702 and the enhanced image 704 (when the laser intensity is 1.5 n₀) are shown whereas in FIG. 7(d), 2D projections of the original image 706 and the enhanced image 708 (when the laser intensity is 2.0n₀) are shown. It can be seen that the enhanced images are more uniformly illuminated.

4.2 Confocal Microscopy

To demonstrate the effectiveness of method 100, 3D images of neuro stem cells from mouse embryo, with nucleus stained with Hoescht 33342, are enhanced. The images were acquired using an Olympus Point Scanning Confocal FV 1000 system. Imaging was done with a 60× water lens with a Numerical Aperture of 1.2. Diode laser 40 nm was used to excite the neurospheres stained with Hoescht. Sampling speed was set at 2 μm/pixel. The original microscope images are of size 512×512×n_{z} voxels with a resolution of 0.137 μm in the x- and y-direction and 0.2 μm in the z-direction where n, is the number of z-stacks in the image.

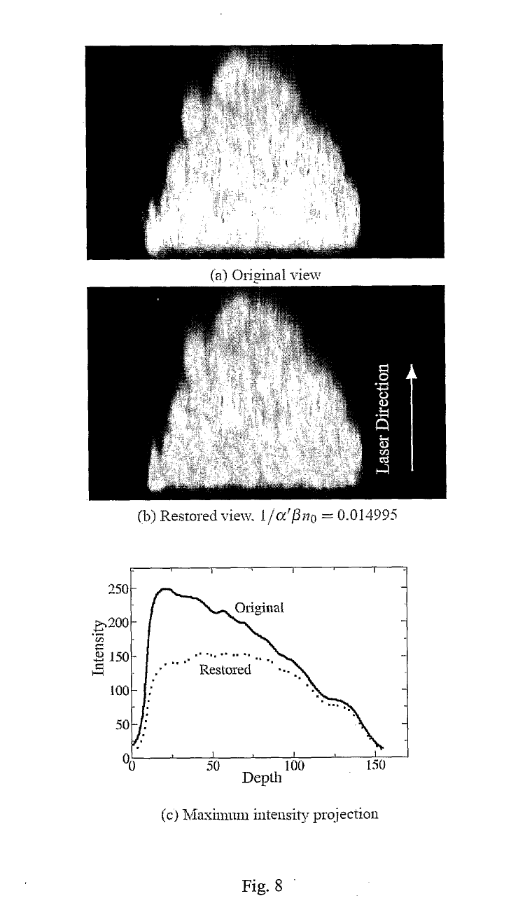

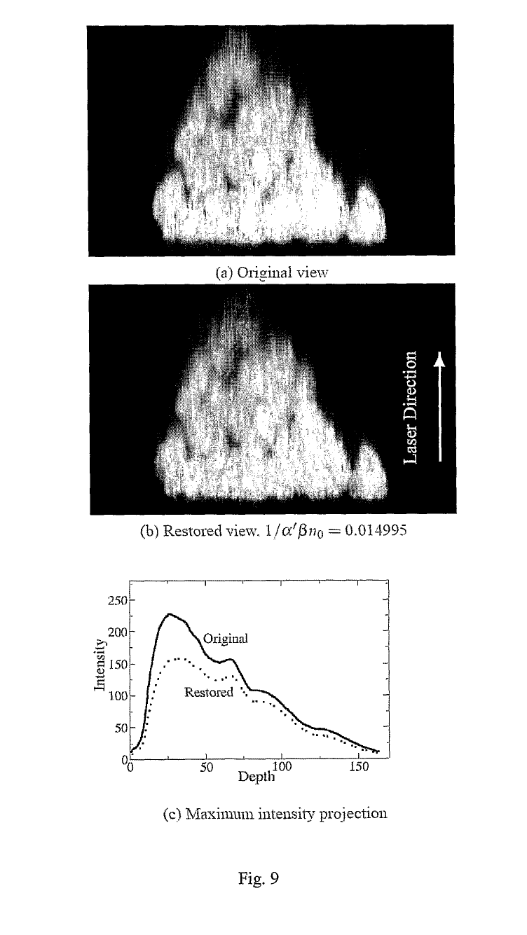

To reduce the computation time, the original images are downsampled to 256×256×n_{z} voxels by averaging the voxels in the x- and y-direction while maintaining the resolution in the z-direction. FIGS. 8 and 9 show enhancement results for 256×256×n_{z} voxels images enhanced using Equation (20). The confocal microscopy images shown in FIGS. 8 and 9 have 155 z-stacks and 163 z-stacks (i.e. n_{z}=155 and n_{z}=163) respectively. More specifically, FIGS. 8(a) and 9(a) show the maximum intensity projection onto the yz-plane of the respective original images (denoted as original view in FIGS. 8 and 9) whereas FIGS. 8(b) and 9(b) show the maximum intensity projection onto the yz-plane of the respective enhanced images (denoted as restored view in FIGS. 8 and 9). In FIGS. 8(b) and 9(b), the adjusted tuning parameter is set as 1/α′βn₀=0.014995. It can be seen that this gives optimal enhancement results. FIGS. 8(c) and 9(c) show the maximum intensity projection (averaged over the brightest 0.1% voxels in the xy plane) onto the z-axis of both the original (solid-lines) and the enhanced images (dashed-lines). Since the illuminating laser originates from the bottom, one can easily observe from FIGS. 8 and 9 that for the original image (in FIG. 8(a) or 9(a)), the voxels are much brighter at the bottom of the image and the intensity of the image drops towards the top of the image (in other words, the illumination is not uniform). However, as shown in FIGS. 8(b) and 9(b), the illumination becomes uniform after enhancement. Furthermore, FIGS. 8(c) and 9(c) clearly show the difference between the intensity profiles of the original (solid lines) and enhanced (dashed lines) images. In addition, as shown in FIGS. 8 and 9, over-exposed areas in the bottom z-stacks are also correctly compensated by the enhancement method 100. Thus, it can be seen from FIGS. 8 and 9 that restoring an image using method 100 is advantageous as uniform illumination in the enhanced image can be achieved. Other image enhancement methods such as histogram equalization can then be used on this enhanced image. Although the enhanced image is also darker on the average, many image processing techniques are robust against the average voxel intensity.

4.3 Side Scattering Microscopy

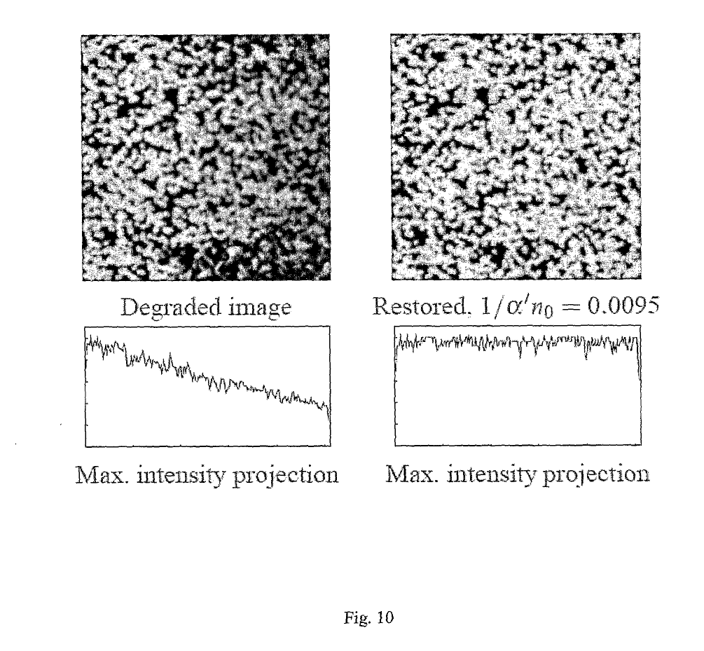

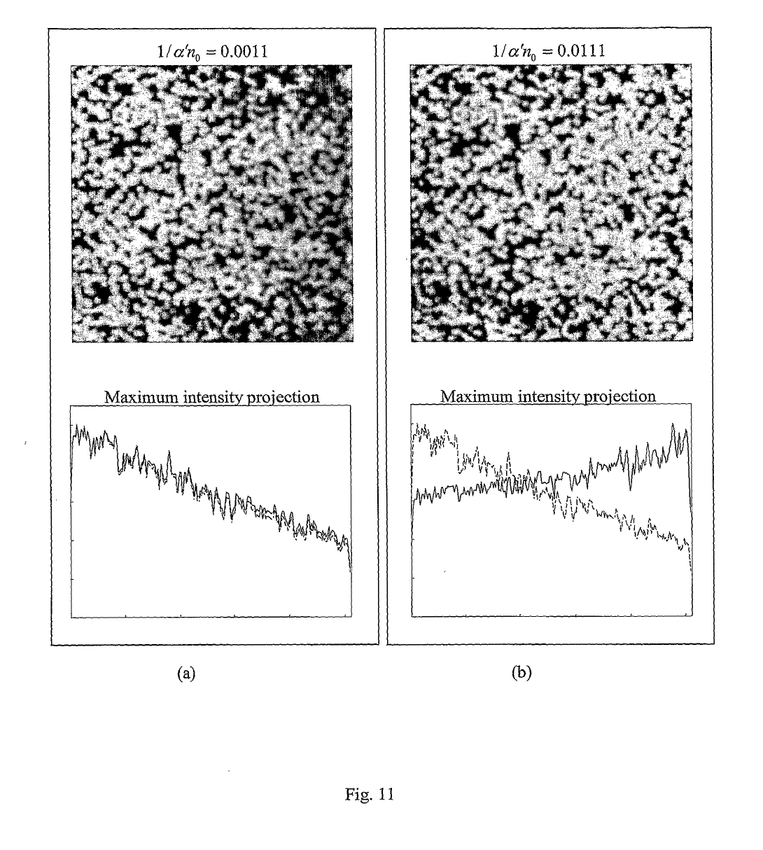

Calculations for side scattering geometry on synthetically degraded images were performed. A synthetic image with non-uniform illumination (i.e. with the maximum intensity projection falling off exponentially assuming that the light source comes from the left) was generated from an image of uniform illumination. FIG. 10 shows enhancement results for a 256×256 pixels image (the enhanced image is labeled as “Restored” in FIG. 10). In FIG. 10, Equation (27) is used to enhance the image. n₀ is the incident light intensity and α′ is a geometric factor that is usually unknown. The tuning parameter 1/α′n₀ can be adjusted to obtain optimal results. FIG. 11(a) shows the enhanced image when a small 1/α′n₀ (0.0011) is used whereas FIG. 11(b) shows the enhanced image when a large 1/α′n₀ (0.0111) is used. As can be seen from FIGS. 11(a) and (b), when a small 1/α′n₀ is used, the image is hardly enhanced and when a large 1/α′n₀ is used, there is over-compensation of the attenuation effect. The optimal value of 1/α′n₀ is 0.0095 which was used to obtain the enhanced image in FIG. 10. As shown in FIG. 10, the enhanced image is almost perfectly (uniformly) illuminated when 1/α′n₀ is set to 0.0095.

As discussed above, method 100 is advantageous as it is capable of obtaining enhanced images with uniform illumination. In other words, using method 100 to enhance images can alleviate the fundamental light attenuation and scattering problem for light microscopy.

The derivation of the equation b=G·u used in method 100 is formulated on strong theoretical grounds and is based on fundamental laws of physics, such as conservation laws represented by the continuity equation. Furthermore, a field theoretical approach is used in the derivation.

Method 100 is a type of physics based restoration method and physics based restoration methods have many advantages over model based methods of contrast enhancement (e.g. histogram equalization). Model based methods [15], [16], [17] generally assume that the image properties are constant over the entire image, this assumption is violated in weather degraded images. Moreover, physical models are built upon the laws of physics, which is most likely an undeniable truth. Physics based restoration techniques can be used in many applications. One aspect of such restoration techniques is its validity through several orders of magnitudes of physical length scales. In aerial surveillance, the physical length scale is of the order of 10 km and in underwater surveillance, the physical length scale is of the order of ≈10 m.

Although physics based restoration methods have been used in the restoration of weather degraded images, they have not been truly explored in the area of image enhancement for light microscopy (which has a physical length scale of ≈100 μm. Method 100, being a type of physics based restoration technique used on microscopy images, extends the length scales of physics based restoration to 8 orders of magnitudes.

Even though method 100 is a type of physics based restoration technique, it is radically different from all existing physics based restoration techniques. In the existing physics based restoration techniques, a constant absorption coefficient in the attenuating medium is assumed whereas this is not assumed in method 100. Moreover, in method 100, no distinction is made between the sample and the attenuating medium. A general set of equations is derived and is used in method 100 to handle any geometrical setup in the image acquisition. To use method 100, one only needs to specify details of the light source and the detection equipment such as a camera. On the other hand, existing physics based methods [5], [6], [7], [8], [9], [10], [11], [12], [13] cannot even be applied to three dimensional microscopy images due to the following reasons. Firstly, existing physics based methods “remove” the attenuation media to retrieve a two dimensional scene. On the contrary, in method 100, the attenuation media also contain the image information. This is advantageous as it is necessary to restore the true signals of the media instead of removing them. Secondly, existing methods assume a uniform attenuation medium, an assumption that is strongly violated in microscopy images. On the contrary, such an assumption is not made in method 100.

### REFERENCES

1. James B. Pawley ed. Handbook of Biological Confocal Microscopy Third Edition (Springer, New York, 2005).

2. D. Kundur, D. Hatzinakos, “Blind image deconvolution”, IEEE Signal Process. Mag. pp. 43-64, May 1996.

3. P. Shaw, “Deconvolution in 3-D optical microscopy,” Histochem. J. 26 1573-6865 (1994).

4. P. Sarder, and A. Nehorai, “Deconvolution methods for 3-D fluorescence microscopy images,” IEEE Signal Process. Mag. pp. 32-45, May 2006.

5. J. P. Oakley and B. L. Satherley, “Improving image quality in poor visibility conditions using a physical model for degradation,” IEEE Trans. Image Process 7(2), 167-179 (1998).

6. J. Tan and J. P. Oakley, “Enhancement of color images in poor visibility conditions,” Proc. Intl Conf. Image Process. 2, 788-791 (2000).

7. K. Tan and J. P. Oakley, “Physics Based Approach to color image enhancement in poor visibility conditions,” J. Optical Soc. Am. 18(10), 2460-2467 (2001).

8. Y. Y. Schechner, S. G. Narasimhan, and S. K. Nayar, “Polarization based vision through haze,” Appi. Opt. 42(3), 511-525 (2003).

9. Y. Y. Schechner, and N. Karpel, “Clear underwater vision,” Proc. IEEE Conf. Computer Vision and Pattern Recognition 1, 536-543 (2004).

10. S. G. Narasimhan and S. K. Nayar, “Contrast restoration of weather degraded images,” IEEE Trans. Pattern Anal. Mach. Intel(25(6), 713-724 (2003).

11. S. G. Narasimhan and S. K. Nayar, “Vision and the atmosphere,” Intl J. Computer Vision 48(3), 233-254(2002).

12. S. G. Narasimhan and S. K. Nayar, “Removing weather effects from monochrome images,” Proc. IEEE Conf. Computer Vision and Pattern Recognition 2, 186-193 (2001).

13. S. G. Narasimhan and S. K. Nayar, “Chromatic framework for vision in bad weather,” Proc. IEEE Conf. Computer Vision and Pattern Recognition 1 598-605 (2000).

14. R. Kaftory, Y. Y. Schechner, and Y. Y. Zeevi, “Variational distance-dependent image restoration,” Proc. IEEE Conf. Computer Vision and Pattern Recognition (2007).

15. S. Geman and D. Geman, “Stochastic relaxation, Gibbs distributions, and the Bayesian restoration of images,” IEEE Trans. Pattern Anal. Mach. lntell 6, 721-74 1 (1984).

16. L. Rudin, S. Osher, and E. Fatemi, “Nonlinear total variation based noise removal algorithms,” Physica D 60 259-268 (1992).

17. P. L. Combettes, and J. C. Pesquet, “Image restoration subject to a total variation constraint,” IEEE Trans. Image Process. 13, 1213-1222 (2004).

18. A. R. Patternson, A first course in fluid dynamics (Cambridge university press 1989).

19. J. B. Pawley, Handbook of Biological Confocal Microscopy (Springer 1995).

20. M. Capek, J. Janacek, and L. Kubinova, “Methods for compensation of the light attenuation with depth of images captured by a confocal microscope,” Microscopy Res. Tech. 69, 624-635 (2006).

21. P. S. Umesh Adiga and B. B. Chaudhury, “Some efficient methods to correct confocal images for easy interpretation,” Micron. 32, 363-370 (2001).

22. K. Greger, J. Swoger, and E. H. K. Stelzer, “Basic building units and properties of a fluorescence single plane illumination microscope,” Rev. Sci. Instrum 78, 023705 (2007).

23. J. Huisken, J. Swoger, F. Del Bene, J. Wittbrodt, and E. H. K. Stelzer, “Optical sectioning deep inside live embryos by selective plane illumination microscopy,” Science 305, 1007-1009(2004).

24. P. J. Verveer, J. Swogerl , F. Pampaloni, K. Greger, M. Marcello, E. H. K. Stelzer. “High-resolution three dimensional imaging of large specimens with light sheet-based microscopy,” Nature Methods 4(4), 311-313 (2007).

25. P. J. Keller, F. Pampaloni, E. H. K. Stelzer, “Life sciences require the third dimension,” Curr. Opin. Cell Biol. 18, 117-124(2006).

26. J. G. Ritter, R. Veith, J. Siebrasse, U. Kubitscheck. “High-contrast single-particle tracking by selective focal plane illumination microscopy,” Opt. Express 16(10), 7142-7152 (2008).

1. A method for enhancing a microscopy image of a sample, the microscopy image having been formed by illuminating the sample in an illumination direction and using a camera to capture light scattered by the sample, respective portions of the microscopy image representing the amount of scattered light captured from respective elements of the sample,
the method comprising:
(i) using a mathematical expression which links the components of the microscopy image and the values of a scattering parameter for multiple respective elements of the sample, to obtain the values of the scattering parameter, the respective value of the scattering parameter for each element of the sample being indicative of the tendency of that element of the sample to scatter incident light; and
(ii) forming an enhanced image of the sample using the obtained values of the scattering parameter.

2. A method according to claim 1 in which, for each given said element of the sample, the mathematical expression expresses the values of the scattering parameter of the given said element in terms of the values of the scattering parameter of elements which are in the illumination direction as the given said element,
operation (i) including obtaining the values of the scattering parameter successively for elements successively further in the illumination direction.

3. A method according to claim 1, wherein the microscopy image is acquired using confocal microscopy or single plane illumination microscopy.

4. A method according to claim 1 in which the enhanced image is an image in which each portion corresponds to a respective element of the sample, and has an intensity corresponding to the obtained value of the scattering parameter of that element.

5. A method according to claim 1, wherein the image is linearly normalized prior to obtaining the values of the scattering parameter.

6. A method according to claim 1, wherein the image is down-sampled prior to obtaining the values of the scattering parameter.

7. A method according to claim 1, further comprising resealing intensities of pixels in the enhanced image to the range of 0-(2ⁿ−1) where n is the number of bits used to represent the pixels.

8. A method according to claim 1 in which the mathematical expression includes a tunable parameter, the method including selecting a value for the tunable parameter which gives substantially constant average intensity in the enhanced image.

9. A method according to claim 1, wherein the mathematical expression is consistent with an assumption that the light intensity at each element of the sample includes only a negligible component due to scattering from other elements of the sample.

10. A method according to claim 1 in which the mathematical expression is of the form b=G·u, wherein b and u are vectors having a component for each of a plurality of respective points in a three-dimensional space including the sample, b comprises data values representing the amplitude of the remaining incident light following attenuation, u comprises data values representing the degree to which each point generates scattered light, and G is a matrix incorporating the scattering parameters.

11. A method according to claim 1 in which the mathematical expression expresses the value of the scattering parameter for a given said element of the sample by employing one or more average parameters, each indicating an average of the value of the scattering parameter over a given said element of the sample by employing one or more average parameters, each indicating an average of the value of the scattering parameter over a corresponding region which encircles a line extending parallel to the illumination direction to the given element of the sample.

12. A method according to claim 11 in which the illumination is performed by transmitting light through a lens and collecting the scattered light through the same lens, the mathematical expression employing a said average parameter for each of a plurality of said regions which are discs between the lens and the given element of sample, each disc being parallel to the lens.

13. A method according to claim 1, wherein the sample is a planar sample, which is illuminated in an illumination direction in the plane of the same, and the scattered light is collected by a camera spaced from the sample in a direction transverse to the plane of the sample.

14. A computer system having a processor and a data storage device storing program instructions,
the program instructions being operative upon being performed by the processor to cause the processor to enhance a microscopy image of a sample, the microscopy image having been formed by illuminating the sample in an illumination direction and using a camera to capture light scattered by the sample, respective portions of the microscopy image representing the amount of scattered light captured from respective elements of the sample,
said enhancement of the microscopy image comprising:
(i) using a mathematical expression which links the components of the microscopy image and the values of a scattering parameter for multiple respective elements of the sample, to obtain the values of the scattering parameter, the respective value of the scattering parameter for each element of the sample being indicative of the tendency of that element of the sample to scatter incident light; and
(ii) forming an enhanced image of the sample using the obtained values of the scattering parameter.

15. A tangible data storage device, readable by a computer system and containing program instructions operable by a processor of the computer system to cause the processor to enhance a microscopy image of a sample, the microscopy image having been formed by illuminating the sample in an illumination direction and using a camera to capture light scattered by the sample, respective portions of the microscopy image representing the amount of scattered light captured from respective elements of the sample,
said enhancement of the microscopy image comprising:
(i) using a mathematical expression which links the components of the microscopy image and the values of a scattering parameter for multiple respective elements of the sample, to obtain the values of the scattering parameter, the respective value of the scattering parameter for each element of the sample being indicative of the tendency of that element of the sample to scatter incident light; and
(ii) forming an enhanced image of the sample using the obtained values of the scattering parameter.
